(19) United States
(12) Patent Application Publication
(10) Pub. No.: US 2005/0131797 A1
(43) Pub. Date: Jun. 16, 2005

(54) Method, system and computer program product for trading in an online market

(76) Inventors: Rema Ananthanarayanan, New Delhi (IN); Manoj Kumar, Yorktown Heights, NY (US); Rakesh Mohan, Cortlandt Manor, NY (US)

Correspondence Address: T. Rao Coca;IBM Corporation, Almaden Research Center, 650 Harry Road, San Jose, CA, 95120, US

(21) Appl. No.: 10/734,798

(22) Filed: Dec. 12, 2003

(51) Int. Cl. G06F 17/60

(52) U.S. Cl. 705/37

(57) ABSTRACT

The present invention provides a method, system and computer program product for increasing the trading efficiencies for trading parties in an online market. The present invention couples the bilateral negotiations with the existing trading mechanisms. A buyer or seller in an online market can selectively execute the trading mechanism or invoke bilateral negotiations in order to arrive at attractive and feasibility of the trading deals. An alternate embodiment of the present invention provides method system and a computer program product for increasing the trading efficiency of the online market. The online market is regulated in order to maximize the number of trading parties that are able to strike trading deals within the regulations of the online market.

### FIELD OF THE INVENTION

The present invention relates, in general, to trading in online market places. In particular, the present invention relates to improving trading efficiencies in an online market by enabling the use of trading mechanisms and bilateral negotiations together in the online market.

### BACKGROUND

From times immemorial, business across the world has been primarily conducted through physical trading. Physical trading between two trading parties involves one trading party buying, either in cash or in kind, the products and/or services offered by another trading party. One of the oldest physical trading methods, the barter system, involved exchange of products and/or services offered by two trading parties.

Gradually, it was realized that geographical constraint was one of the biggest constraint in physical trading. The trading options available to a trading party are heavily governed by the location of the trading party. Consider a case wherein a trading party located in New Orleans wishes to auction its products. Options available for such a company is limited by the number of trading parties, in and around New Orleans, who are interested in the products sold by the company. Another disadvantage of geographical constraint is the small size of the target customer base. With the growing level of competition amongst companies, the companies that do well are the ones who increase their target customer base in order to emerge as the market leader. This, again, reinforces the need for trading parties to overcome geographical constraints in order to be more profitable and to beat competition.

The advent and development of the Internet over the past few years has provided a way to overcome this geographical constraint. Several attributes of the Internet, such as its wide and global reach and its use as an effective and secure means of exchange of information/data, are conducive for its use as a medium of trading. Such a market place, where trading is effected over the Internet is called an online market. Online markets are rapidly gaining wide acceptance as a preferred means of conducting business.

Present day online markets enable trading amongst different combinations of entities (trading parties). Such combinations include Business to Business (B2B) trading, Business to Consumer (B2C) trading and Consumer to Consumer (C2C) trading. B2B online markets enable business entities (such as construction companies and cement companies) to trade with each other over the Internet. An example of such a B2B online market place is metalsite.com, Pittsburgh, Pa., US that enables buying and selling of metals. B2C online markets enable business entities to sell their products and services directly to the end customer. An example of a B2C market place is Amazon.com, Seattle, Wash., US that sells products such as books, videos, etc. directly to online customers. C2C online markets enable consumers to sell and buy products from other customers. An example of a C2C market place is eBay Inc., San Jose, Calif., US that is an online market for products and services provided by individual customers (and certain business entities).

As online markets started gaining popularity, trading mechanisms and negotiation processes, which were typically used in physical trading, were implemented in the online markets. Trading mechanisms include ascending price auctions, descending price auctions, call markets, continuous double auctions, reverse auctions and the like. Implementation of such mechanisms in online markets enabled the availability of a large number of options to the trading parties involved. For instance, a New Orleans based construction company undertaking a construction project in Chicago could receive Request For Quotes (RFQs) from cement companies all across the United States, and more specifically from regions in and around Chicago. Alternatively, the construction company, without much trouble, may opt for continuous double auctions in order to meet its requirements. Thus, implementation of trading mechanisms on online markets enabled the involved trading parties to explore a larger number of options, both in terms of mechanisms and in terms of the number of trading parties available for trading, than that explored in physical trading.

One implementation of trading mechanisms in online markets is described in published patent application US20020062276A1, titled “Wireless distributed certified real time bidding and tracking system for live events”. The patent application discloses a wireless distributed certified real time bidding and tracking system for live events, such as a live auction. The attendees of the auction include a mix of live bidders and wireless bidders. The wireless bidders get regular intimations about the start, end and the contents (that are to be auctioned) in the auction process. A time-date stamp associated with actions taken on wireless device enables a fair conduct of the auction process.

Present day online markets also support online bilateral negotiations. Such negotiations, which were an integral part of the traditional physical trading, enable the buyer and the seller to customize the trading deal as per their mutual needs and satisfaction.

One existing solution that enables bilateral negotiations in an online market is described in the published patent application US20010037284A1, titled “Negotiated right exchange system and method”. The patent application discloses a repurchase agreement trading system that includes a number of trading terminals and a central processor. The central processor establishes communication between the trading terminals. Each of the trading terminals presents a hierarchal list of repurchase agreement opportunities, and a user at a trading terminal can select one of the repurchase agreement opportunities and can negotiate directly with potential repurchase agreement counterparty about the respective repurchase agreement opportunity.

As is evident from the above discussion, the advantages offered by trading mechanisms are exclusive (and different) from those offered the bilateral negotiation processes. On one hand, it is desirable for a trading party to follow the trading mechanisms in order to explore a larger number of options without any geographical constraints. On the other hand, bilateral negotiation process enables a trading party to customize the trading deal as per his/her need and satisfaction. It is desirable for a trading party to utilize these mutually exclusive advantages offered by the trading mechanisms, and by the negotiation processes. However, none of the heretofore-discussed solutions addresses this need.

One solution, which partially addresses this need is provided in European patent EP1246112A1, titled “Request for quote (RFQ) and inside markets”. The patent discloses systems and methods for rule-based bilateral negotiation of quotes in response to request for quotes (RFQ). Each trading party is provided with a user-interactive trading interface for submitting and receiving an RFQ. The RFQ may be forwarded to a select group of entities, determined automatically or by the requesting trading party. The market entities may respond to the RFQ with a quote via the user-interactive trading interface. A rule-based negotiation session may be initialized upon receiving the quote from the market entity.

The above patent offers advantages only for cases where Request For Quotes (RFQs) is the existing trading mechanism. It is desirable for the trading party if other trading mechanisms, such as English auctions, Dutch auctions, call markets and the like are also coupled with the bilateral negotiation process. It is also highly desirable by the trading party if it has the flexibility to selectively implement either the predefined mechanisms or the bilateral negotiation process at each phase of online trading. This will enable the trading party to precisely address the lack of availability of options issue or the lack of need and satisfaction in trading deals issue as and when the need arises.

Therefore, what is needed is a method and system that enables trading parties to selectively implement either the predefined mechanisms, or the bilateral negotiation processes at each phase of online trading. Further, it is also desirable that the trading parties may flexibly interchange between mechanisms and negotiation processes in order to strike attractive and feasible trading deals with other trading parties. Such a solution enables trading parties to gain benefits of a larger number of trading options, as well as that of customizing the trading deal as per trading party's need and satisfaction.

### SUMMARY

A general object of the present invention is to increase the trading efficiencies of trading parties in an online market by enabling them to strike attractive and feasible trading deals.

An object of the present invention is to provide the trading parties with the flexibility to selectively execute trading mechanisms and bilateral negotiations in order to arrive at attractive and feasible trading deals.

Another object of the present invention is to enable the trading parties to customize trading offers through negotiation process in order to arrive at attractive and feasible trading deals.

Another object of the present invention is to provide the trading parties with a large number of trading options.

A further object of the present invention is to increase the trading efficiency of the online market by maximizing the number of trading parties that are able to strike a trading deal with other trading parties.

In order to attain the abovementioned objectives, the present invention provides a method, system and a computer program product. In accordance with a preferred embodiment of the present invention, the method to increase trading efficiencies of trading parties is carried out by coupling bilateral negotiations with the existing trading mechanisms. The user starts the process by specifying his/her requirements. After the specification of requirements, the user may initiate the trading process by executing a trading mechanism of his/her choice. At any stage of the trading mechanism, if the user feels that the available offers can be tailored to arrive at a mutually beneficial solution, then the user may invoke bilateral negotiations with the party/parties of his/her choice. The user may also invoke bilateral negotiations before executing the trading mechanism. The user may also switch from the bilateral negotiations to trading mechanism and vice-versa. The user may selectively repeat the execution of the trading mechanism and the invoke of bilateral negotiations in accordance with his/her need and satisfaction. After the user has executed trading mechanism and conducted bilateral negotiations, the user evaluates the offers available to him/her. The evaluation of offers is done to determine whether there are any offers that are attractive and feasible for both the trading parties. In case, there are such offers, the parties strike a deal. Otherwise, they leave the online market framework without striking a deal.

In an alternate implementation, the present invention may be implemented in a regulated online market environment. The regulations in the online market are introduced in order to increase the trading efficiency of the online market that, in turn, is governed by the number of trading parties that strike a deal within the regulations of the online market. An example of regulations may be that a trading party cannot trade for a time-period ‘t’ after striking ‘n’ trading deals. The trading parties can use the present invention in such a regulated environment in order to get attractive and feasible trading deals within the constraints of the online market.

The system for enabling the present invention comprises at least one client and at least one server. The clients and server comprise various modules, such as an initial requirement specification module, a trading module and a deal conclusion module, which enable a user to execute the present invention. These modules may reside on the client or the server or both the client and server in various embodiments of the present invention. Also, the client and the server may comprise any number of modules to enable the present invention. Besides various modules, the server includes a requirements specifications repository, a user repository and a past trading deals repository.

### BRIEF DESCRIPTION OF THE DRAWINGS

The preferred embodiments of the invention will hereinafter be described in conjunction with the appended drawings, provided to illustrate and not to limit the invention and in which like designations denote like elements.

FIG. 1 illustrates various types of trading mechanisms.

FIG. 2 illustrates an exemplary online market in which a buyer interacts with a seller.

FIG. 3 illustrates a system for increasing the trading efficiencies of trading parties in an online market in accordance with a preferred embodiment of the present invention.

FIG. 4 illustrates an exemplary state transition diagram for bilateral negotiations.

FIG. 5 illustrates a method of increasing the trading efficiencies of trading parties in an online market in accordance with a preferred embodiment of the present invention.

FIG. 6 illustrates the method of invoking bilateral negotiations in accordance with a preferred embodiment of the present invention.

FIG. 7 describes an example in which a seller invokes bilateral negotiations in the lifecycle of a sealed bid auction, to facilitate the reaching of a deal/agreement.

FIG. 8 illustrates a system for increasing the trading efficiencies of trading parties in an online market in accordance with an alternate embodiment of the present invention.

FIG. 9 illustrates an exemplary computer system for implementing the present invention.

### DESCRIPTION OF PREFERRED EMBODIMENTS

For convenience, terms that have been used in the description of preferred embodiments are defined below. It is to be noted that these definitions are given merely to aid the understanding of the description, and that they are, in no way, to be construed as limiting the scope of the invention.

Definitions

online market: online market is an electronic framework that enables the sale and purchase of products or services amongst two or more parties over the Internet. The party that offers the products or services is referred to as seller and the party that is willing to buy such products or services is referred to as buyer. There may be multiple buyers or sellers in an online market. The generic terms ‘buyer’ and ‘seller’ have been used to include buyers and sellers of products and services, and to represent the general category of service requesters and service providers, respectively. The role of buyer or seller could also be played by the online market administrator.

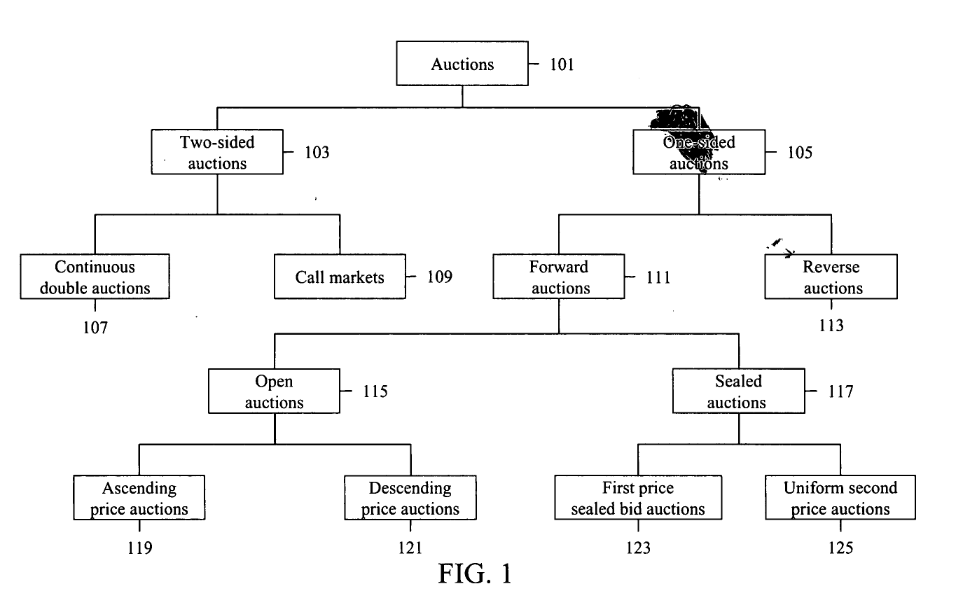

Auction: Auction is a trading mechanism in which the price of goods or services is determined by bidding. Once the bidding is complete, the goods or services are offered to the highest bidder. FIG. 1 illustrates various types of trading mechanisms. As shown in FIG. 1, auctions 101 can primarily be classified into two categories: two-sided auctions 103 and one-sided auctions 105. Two-sided auctions: In two-sided auctions 103, both buyers and sellers submit their bids. These bids are then matched according to their needs. As shown in FIG. 1, the two-sided auctions 103 are of two types: continuous double auctions 107 and call markets 109.

Continuous double auctions: In continuous double auctions 107, the bids submitted by buyers and sellers are matched as soon as they are detected. Multiple individual transactions are being carried out at one moment and the trading does not stop as each auction is concluded. Trading at New York Stock Exchange is an example of continuous double auctions.

Call markets: In call markets 109, the matching of bids submitted by buyers and sellers is not continuous. The bids are first collected over a specified interval of time and thereafter matched as per the need and satisfaction of buyers and sellers.

One-sided auctions: As the name suggests, only one party submit the bids in one-sided auctions 105. This party may be either a buyer or a seller. As shown in FIG. 1, one-sided auctions 105 are of two types: forward auctions 111 and reverse auctions 113.

Forward auctions: Auctions in which the sellers offer products or services and the buyers submit their bids are called forward auctions 111. The product or the service is offered to the buyer with the highest bid. As shown in FIG. 1, forward auctions 111 are of two types: open auctions 115 and sealed auctions 117.

Open auctions: In open auctions 115, bid submitted by a trading party (buyer) is known to the other trading parties. Moreover, the trading parties (buyers) can modify their bids from time to time depending upon the bids submitted by the other trading parties. As shown in FIG. 1, open auctions 115 are of two types: ascending price auctions 119 and descending price auctions 121.

Ascending price auctions: In ascending price auctions 119, a reserve price (the minimum acceptable price) is attached to a product or a service and the prospective buyers are asked to increase their bids. The bidding continues till there is no increase in the bid or the time for the bidding is over. The product or service is then sold to the highest bidder.

Descending price auctions: In descending price auctions 121, the bidding starts at a very high price and is progressively lowered until a buyer claims a product or a service by using a predefined signal (such as calling “mine”) indicating the end to the auction.

Sealed Auctions: In sealed auctions 117, the trading parties submit their bids in such a manner that the other trading parties do not have the knowledge about the submitted bids. Normally, the trading parties are allowed to submit their bids only once. As shown in FIG. 1, the sealed bid auctions 117 are of two types: first price sealed bid auctions 123 and uniform second price auctions 125.

First price sealed bid auctions: In first price auctions 123, the bids are submitted by the buyers without disclosing them to other trading parties. After the bids have been submitted, the bids are opened and the highest bid is determined. The product or the service is awarded to the person with the highest bid. The highest bidder then pays the amount that he/she bid.

Uniform price auctions: In uniform price auctions 125, the bids are submitted by the parties in a secretive manner like in first price sealed bid auctions 123. However, unlike first price auctions 123, the product or service is awarded to the highest bidder at the second highest bid. That is, the highest bidder has to pay the amount of the second highest bid. This type of auction is meaningful when there are multiple goods or services to be auctioned. In such a case, all the winning bidders pay equal amount (equal to the second highest bid) for the similar goods or services.

Reverse Auctions: Unlike forward auctions 111, the bids in the reverse auctions 113 are submitted by the sellers. The buyer specifies his/her products or services requirements and posts these requirements in an online market. The prospective sellers then submit their bids and the product or the service is procured from the seller with the lowest bid.

Negotiations: In the context of online markets, the term negotiations is used to indicate the process whereby two or more parties exchange one or more rounds of offers till they come to a mutually satisfactory agreement, or till they agree upon to stop the process without an agreement. In online markets, the term ‘negotiations’ has also been used more generally to include any trading mechanism such as auctions, other than a fixed-price or posted-price sale. In this patent application, unless specifically stated otherwise, the term ‘negotiations’ has been used in the initial sense, where two or more parties mutually exchange offers in order to come to an agreement.

The present invention describes a method, system and a computer program product for trading in an online market. In a preferred embodiment, the present invention increases the trading efficiencies of trading parties in the online market. The trading efficiency is defined by the attractiveness and feasibility of a trading deal to the trading parties. There may be various approaches of quantifying the attractiveness and feasibility of the trading deal. In one of the approaches, attractiveness and feasibility of the trading deal is directly proportional to a utility function. This has been explained in detail in conjunction with evaluation algorithms. The present invention allows the trading parties to invoke bilateral negotiations in conjunction with the trading mechanisms as will be explained later in detail.

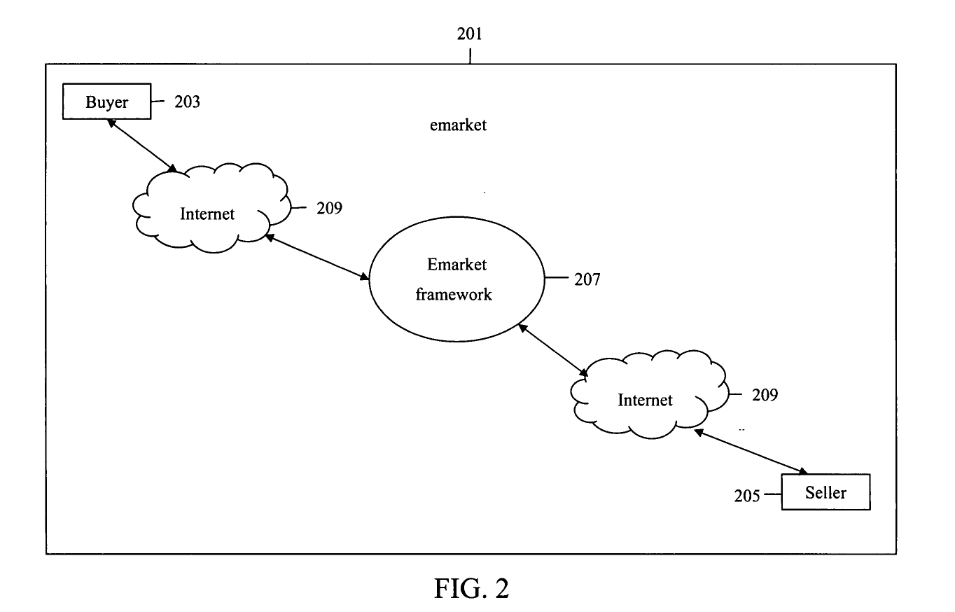

FIG. 2 illustrates an exemplary online market in which a buyer interacts with a seller. online market 201 is implemented by a framework provider. Both buyer 203 and seller 205 access the online market framework 207 using a network, such as the Internet 209. Once buyer 203 and seller 205 enter online market framework 207 they can start trading goods or services. It must be apparent to one skilled in the art that online market 201 depicted in FIG. 2 is an exemplary online market. The online market in accordance with the present invention may contain any number of buyers and sellers.

The system for enabling the implementation of the present invention comprises at least one client and at least one server. The user of the present invention can be a buyer or a seller or an online market administrator. The client and server comprise various modules that enable a user to implement the present invention. Besides other modules, the system includes a requirement specification module, a trading module and a deal conclusion module. These modules may reside on the client, on the server, or on both the client and the server in various embodiments of the present invention.

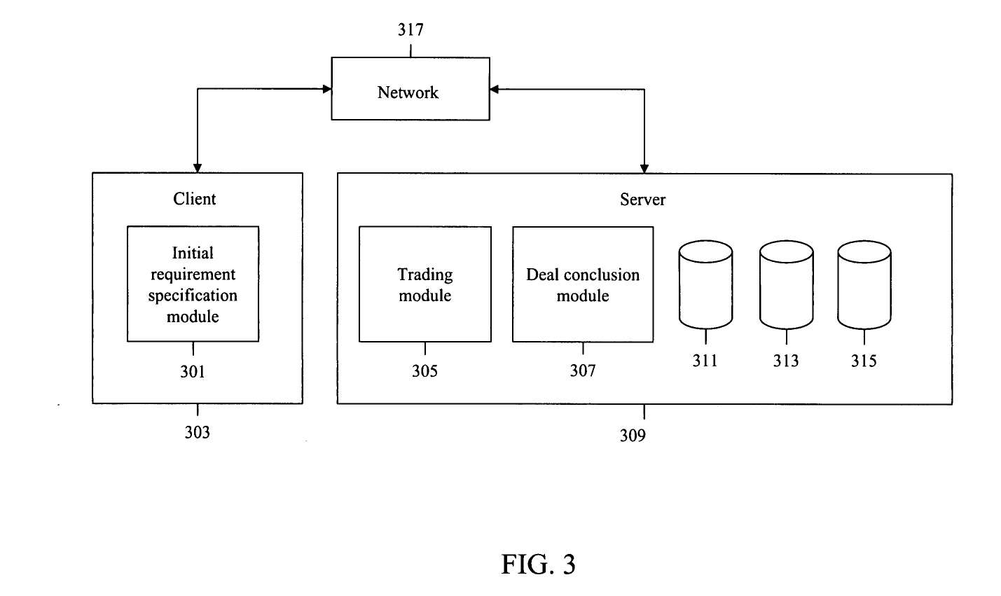

In a preferred embodiment of the present invention illustrated in FIG. 3, initial requirement specification module 301 resides on client 303, while trading module 305 and deal conclusion module 307 reside on server 309. Client 303 is connected to server 309 through a network 317. Apart from these modules, server 309 comprises a number of repositories for storing information related to the complete trading process. Besides other repositories, server 309 includes a requirements repository 311, a user repository 313 and a past trading deals repository 315. These repositories are explained in detail later.

Initial requirement specification module 301 allows the user to specify his/her requirements so that he/she may initiate trading with other parties in the online market. For example, if the user is a buyer, then initial requirement specification module 301 allows the buyer to specify the requirements of the product that he/she desires to procure in the online market. Typically, the inputs to initial requirement specification module 301 may vary considerably depending upon the product/service that the user wishes to buy/sell. For example, if a user wishes to sell a computer, then he/she may specify processing power of processor, type of motherboard, size of monitor and the like whereas the seller of steel sheets may specify composition of steel, strength of the sheets and size of the sheets.

The user may specify his/her requirements to initial requirement specification module 301 in a number of ways. One exemplary way is by using user interfaces provided to the user. User interface may be used to take text inputs from the user. For instance, the user may specify a personal computer, and describe the required attributes such as memory, CPU, hard disk requirements and other attributes as a list of items in a text format. Alternatively, the user may select his/her specification from pre-existing catalogs of menu items and catalogs of supported attributes for each menu item. For instance, the system might already support a catalog of items, in which case the user would be allowed to select an item ‘Personal computer’ directly from a pull-down menu or by browsing through the catalog. The user may then select this item, and specify its various attributes using a pull-down menu of available options. The outputs of requirements specification module 301 are stored in a requirements repository 311 as will be explained in detail later.

Trading module 305 allows the user to trade goods or services in the online market with the other trading parties. The user may select a trading mechanism such as a sealed bid auction to trade the goods or services with other parties. The user may also use the bilateral negotiation process to customize the deal as per his/her satisfaction and need. It must be apparent to one skilled in the art that the bilateral negotiation can be used either as a standalone mechanism, or in conjunction with other trading mechanisms, where it may be used as the starting step of the trading process, as an intermediate step during the trade process, or as its concluding stage, to facilitate the conclusion of other trading mechanisms. Trading module 305 enables the user to execute the trading mechanism and/or invoke bilateral negotiations with the other trading parties. Typically, the input to trading module 305 may comprise selection of a trading mechanism or bilateral negotiations by the user. After the user has selected the trading mechanism or bilateral negotiations, trading module 305 will allow the user to execute the trading mechanism or bilateral negotiations (as per his/her selection) with the other trading parties. Trading module 305 will also enable the user to receive offers form the other trading parties.

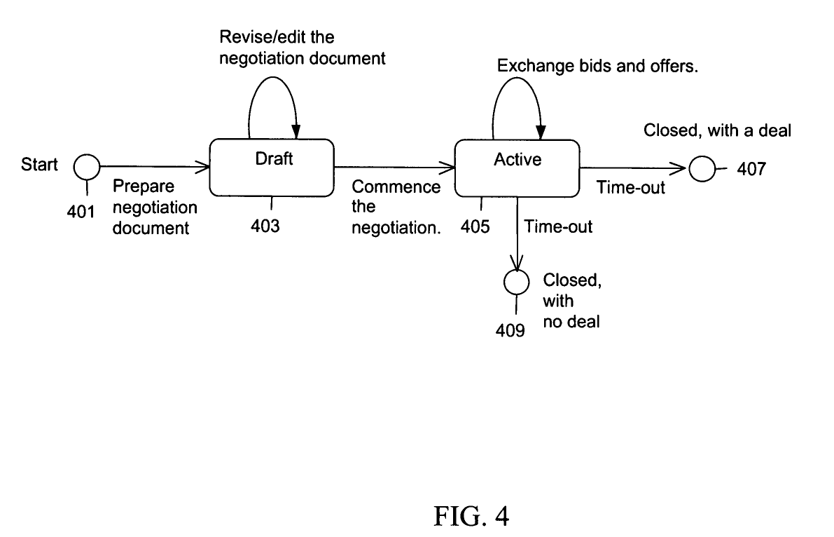

There are a number of ways in which trading module 305 may be implemented. For the purpose of illustration, one exemplary way for implementing trading module 305 is described. The exemplary way uses a state-machine formalism, a system of messaging and notifications to implement the full life cycle of the trading process. The state-machine formalism would describe, for each trading process, a set of allowable states, the inputs to each state, the action triggered by each input, and output for each state for a given input. For instance, while an ascending price auction is in progress, if the time for ending the auction is reached, then at this point in time, trading module 305 would change the state of the auction from ‘Running’ to ‘Closed.’ Changing the state to ‘Closed’ might trigger actions such as deciding the winner, notifying all parties that the auction is closed and so on. It is to be observed that this is just one possible implementation of trading module 305, and multiple implementations are possible to enable trading module 305. An exemplary state transition diagram for bilateral negotiations had been described in conjunction with FIG. 4. In FIG. 4, the start and end states are represented by circles, while the intermediate states are represented by boxes. The transitions from one state to another are shown by arrows, while the text above/below the arrows represents the activity associated with the transition. The states shown in FIG. 4 are Start, Draft, Active, Closed with a deal, and Closed with no deal. Initially the negotiation is at the ‘Start’ state, 401. The initiator (trading party) initiates preparation of a negotiation document, which moves the negotiation to the ‘Draft’ state, 403. The draft document is edited and revised, till it is ready to be communicated to other trading party. When it is time to start the negotiation, the document is communicated to the other party. The document may be in an electronic format. Each trading party may have a standard template for the document and it may include multiple terms and conditions.

Thereafter, the negotiation moves to ‘Active’ state, 405. The two parties to the negotiation exchange bids and offers, till the negotiation ends. The negotiation may move to a closed state when a party accepts a bid that it has received or when a party submits a bid as the final bid, or based on one of the closing rules such as based on a fixed time, or a fixed number of exchanges, or on some inactivity, or a combination of these. As stated above, the negotiation could move from ‘Active’ state 405 to either “Closed with a deal” state 407 or “Closed with no deal” state 409 for many reasons, but for simplicity, this is shown as a time-out in FIG. 4.

Deal conclusion module 307 enables the user to strike or reject a deal with the other trading party on the basis of feasibility and attractiveness of the deal. The input to deal conclusion module 307 are various offers received by the user in the trading process. Deal conclusion module 307 enables the user to evaluate the received offers and thereafter select the best available offer(s). The output of deal conclusion module 307 may be either a deal among the trading parties or a no deal among the trading parties depending upon the attractiveness and feasibility of the trading deal.

Like trading module 305, there are a number of ways in which deal conclusion module 307 may be implemented. For the purpose of illustration, state-machine formalism is used as one exemplary way for enabling deal conclusion module 307. For instance, when the time for the trading process is complete, deal conclusion module 307 may be configured to send a mail to the party that initiated the trading process, to confirm if there is an acceptable offer. If the user specifies ‘Yes,’ then deal conclusion module 307 may be designed to trigger the process of order creation or contract creation. If the user specifies ‘No’ then deal conclusion module 307 may update the internal states and close the trading process.

Requirements repository 311 may contain information related to the requirements of the users. Whenever the user specifies his/her requirements for trading, the requirements are stored in requirements repository 311 so that the other users can see the requirements and respond accordingly. Requirement repository 311 may store the requirements using various data fields, and in various data formats. For instance, the stored data fields may include fields for the set of attributes, the values for each of the attributes, and a set of documents that describe the various terms and conditions of the product. The data may be stored in various database tables in a relational format. It must be apparent to one skilled in the art that the above described data fields and data formats are used only for the purpose of illustration. There can be a number of other data fields and data formats that may be used for storing the data.

User repository 313 stores information related to the trading parties. Various information parameters may be name of the user, address of the user, age of the user and the like. In case, other users require information relating to a particular user, the information stored in user repository 313 can be passed on to them. User repository 311 may store the information using various data fields, and in various data formats. User information may include a number of data fields, such as the normal areas of interest of the user, feedback after earlier trades, qualitative impressions such as the user being risk-prone or risk neutral, user's willingness to spend more time during trading, and similar information. The information may be stored in various database tables in a relational format. It must be apparent to one skilled in the art that the above described data fields and data formats are used only for the purpose of illustration. There can be a number of other data fields and data formats that may be used for storing the user information.

Past trading deals repository 315 stores information related to the past trading deals. This information may serve as a reference for the current users. The current users may refer to the past trading deals and evaluate the current offers. Moreover, the current users may also gauge the credibility of the other users based on the past trading deals struck by them. Past trading deals repository 315 may store the information using various data fields, and in various data formats. Information regarding past trading deals may include fields, such as the price at which a particular product was sold, transaction histories of the relevant trading parties, average selling price of various products, and other such information. The information may be stored in various database tables in a relational format. It must be apparent to one skilled in the art that the above described data fields and data formats are used only for the purpose of illustration. There can be a number of other data fields and data formats that may be used for storing the information.

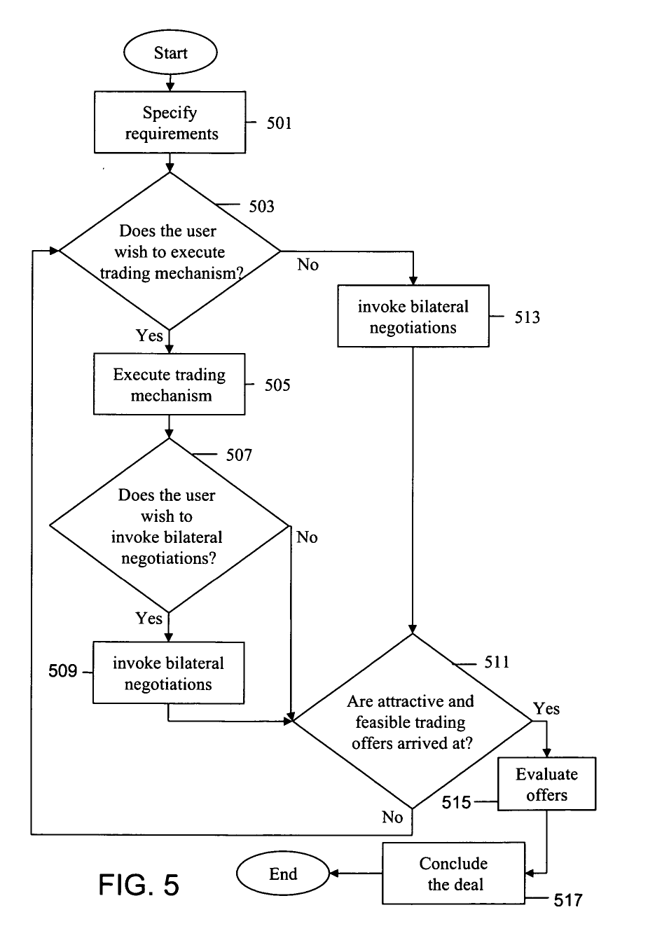

FIG. 5 illustrates a method of increasing the trading efficiencies of parties in an online market. FIG. 5 illustrates the method from both the buyer's and the seller's perspective. As shown in FIG. 5, a user (trading party) specifies his/her requirements at step 501. For example, if a buyer desires to buy a table, then he/she may specify the parameters of the table that suits his/her requirements. Similarly, if a user wishes to sell a tape recorder, then he/she would provide the description of the tape recorder and his/her expectations from the buyer. These expectations may be in terms of minimum acceptable price, terms of delivery etc.

After the requirements have been specified, the user has a choice of either executing a trading mechanism or invoking bilateral negotiations as shown at step 503. If the user wishes to execute a trading mechanism, he/she may execute trading mechanism of his/her own choice, as shown at step 505. The various trading mechanisms may be continuous double auctions, call markets, ascending price auctions, descending price auctions, first price sealed bid auctions, uniform second price auctions and reverse auctions. It must be apparent to one skilled in the art that the trading mechanisms suggested here are exemplary and do not limit the scope of the invention. Various trading mechanisms known in the art may also be used by the user.

After the user has executed the trading mechanism, he/she has a choice of invoking bilateral negotiations with trading parties of his/her choice, in order to customize the trading offer as per his/her satisfaction and needs, as shown at step 507. These trading parties may be selected from a set of trading parties that participated in the trading mechanism executed at step 505. If the user decides to invoke bilateral negotiations, he/she may do so at step 509. This conduct of bilateral negotiations after executing the trading mechanism imparts flexibility to the user, so that he/she may arrive at attractive and feasible trading offers. After invoking the bilateral negotiations at step 509, the user checks whether attractive and feasible trading offers are arrived at, as shown at step 511. However, if the user decides not to invoke bilateral negotiations at step 507, he/she jumps to step 511 as explained above.

Alternatively at step 503, the user may opt for invoking bilateral negotiations, as shown at step 513. The bilateral negotiations started by the user at this step are standalone bilateral negotiations. That is, the user may not initiate trading mechanism prior to invoking bilateral negotiations. He/she may simply select trading parties and start bilateral negotiations with them. For example, the user is a buyer and he wants to buy steel rods from the online market. At the same time, there are a number of sellers who have posted their advertisements regarding the sale of steel rods. The user may select any of these sellers and start bilateral negotiations with them. Two party and multiparty negotiations are effective ways of exploring and discovering solutions that are mutually acceptable to both the trading parties, provided both the trading parties are willing to explore alternatives to their initial positions. In case, the requirements of trading parties are multi-attributed, both the trading parties may trade off one attribute against another, in their search for a common solution, or in their efforts to converge to a mutually acceptable solution. For example, consider a case when a buyer wishes to procure 100 telephones from an online market at a cost of $25 per phone and he wants them to be delivered within 15 days. The trading mechanism allowed the buyer to select a seller who is willing to deliver 100 telephones at a price of $27. However, the seller requires 30 days to deliver the phones at the buyer's place. In this situation, the buyer may tradeoff the cost with the delivery time. He may pay $26 for a telephone to the seller and ask him to deliver the telephones in 20 days. In this manner, both parties may arrive at a mutually acceptable solution by trading off one attribute against the other.

After invoking the bilateral negotiations at step 513, the user checks whether attractive and feasible trading offers are arrived at, as shown at step 511.

If the user feels that there are no attractive and feasible offers, the method provides a provision for selectively repeating the execution of trading mechanisms and invoking of bilateral negotiations. That is, after executing step 511, the user may again go to step 503. This provision of executing the trading mechanism or invoking the bilateral negotiations again imparts flexibility to the user, so that he/she may arrive at attractive and feasible trading offers. It must be apparent to one skilled in the art that multiple trading mechanisms and multiple round of bilateral negotiations may be executed to arrive at an efficient trading deal. Also, the trading mechanisms and the bilateral negotiations may be conducted in any order as per the requirement of the user. Further, the present invention allows the user to invoke multiple bilateral negotiations with the parties of his/her choice. After the user has executed various trading mechanisms and conducted bilateral negotiations and he/she feels that attractive and feasible trading offers have been arrived at, he/she may evaluate the various offers that have arisen during execution of trading mechanism and/or bilateral negotiations as shown at step 515. The offers arising from the conduct of bilateral negotiations are the final offers that are generated after the completion of bilateral negotiations. Various evaluation algorithms known in the art may be used to evaluate the available offers. Some of the evaluation algorithms have been discussed in, “Decisions with Multiple Objectives—Preferences and Value Tradeoffs, by Ralph L. Keeney and Howard Raiffa, Cambridge University Press, 1993”. A notion of utility of a good or a service is widely used for the evaluation of a trading offer, which is multi attributed. The above reference discusses techniques for arriving at the utility functions, based on the individual user's requirements and preferences. Various forms of the utility function such as the multiplicative form and the exponential form may be used for multi-attributed evaluation. An example of multi-attribute evaluation using an additive form of the utility function, also known as the linear weighted sum form of the utility function, is described hereinafter.

Assuming that a good or a service is specified by n attributes. In order to identify a utility function across the n attributes, a user has to do the following:
(a) For each attribute, the user has to identify a weight for each attribute that indicates the importance of that attribute. For instance, for a good that is being evaluated across 3 attributes, say price, quality and delivery time, the user may assign weights of 0.7, 0.2 and 0.1 respectively for each of these 3 attributes. It is to be noted that different users would assign different weights and a same user may assign different weights in different contexts. Further, in this example, the sum of all the weights is 1, but it is not necessary to have sum of the weights as 1. The weights may be normalized subsequently.

(b) For each attribute, the user has to identify a cost function for the different values that the attribute can take. For instance, using the above example, cost function for the price attribute defined by the user is shown in Table 1.

TABLE 1
Cost function for price

| Value | Cost function |
|---|---|
| <$500 | 100 |
| $501-$600 | 80 |
| $601-$750 | 60 |
| $751-$800 | 50 |
| >$800 | 0 |

As shown in Table 1, if the buyer gets a quote for the good below $500, then the buyer assigns it a cost of 100, while if the price is above $800, the buyer assigns it a cost of 0. The cost functions for the intermediate values are as shown in the table.

Similarly, cost functions for other 2 attributes may be defined in the following tables:

TABLE 2
Cost function for Quality

| Value | Cost function |
|---|---|
| Grade A | 100 |
| Grade B | 75 |
| Grade C | 50 |

TABLE 2
Cost function for Delivery Time

| Value | Cost function |
|---|---|
| <2 weeks | 100 |
| 2-4 weeks | 90 |
| 4-6 weeks | 80 |
| >6 weeks | 40 |

The above tables indicate one possible representation of the cost function, and various other representations are possible, such as in terms of linear or nonlinear functions.

Once steps (a) and (b) have been completed, the evaluation of a specific trading offer is done as follows. The utility of an offer is determined as:
Utility=c1(x1)*w1+c2(x2)*w2+c3(x3)*w3+ . . . +cn(xn)*wn,
where n is the number of attributes,
ci(xi) is the cost function for value xi of attribute i and
wi is the weight assigned to attribute i at step (a). Using the above, if a buyer receives a bid of ($650, Grade B, 10 days) for the present 3-attribute example, then the utility of this bid for the buyer is computed as:
   Utility=(60*0.7)+(75*0.2)+(100*0.1)=67

This value has been calculated using tables 1,2 and 3 for values $650, Grade B and 10 days respectively. More is the utility value for a trading offer, more is the attractiveness and feasibility of the trading offer.

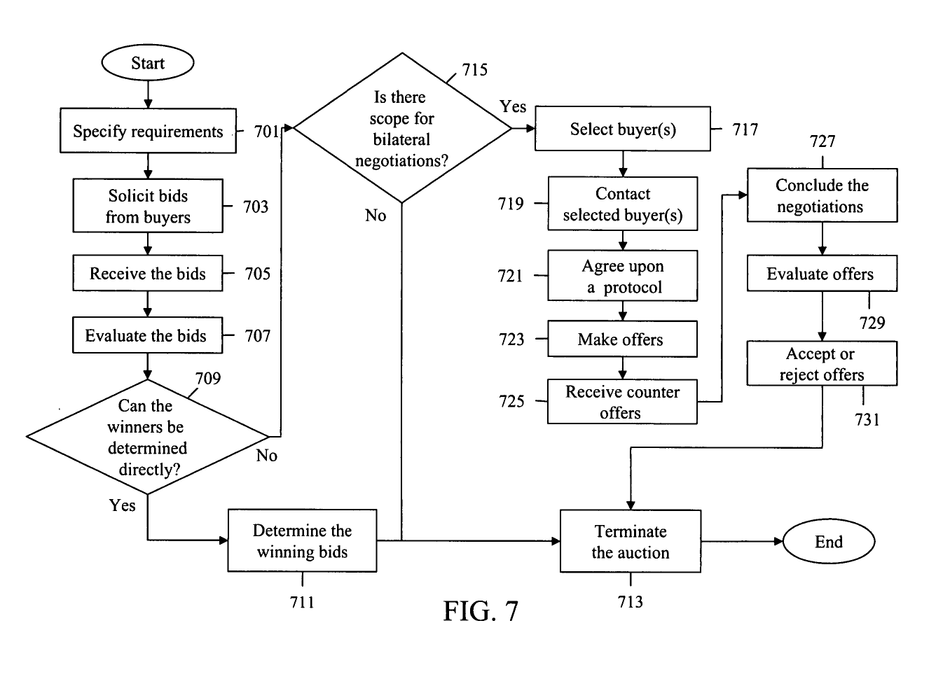

After the user has evaluated the various offers, he/she may conclude the deal as shown at step 517. The deal may either conclude with both parties agreeing on a deal or with the users leaving the online market without striking a deal. The agreement on a deal will depend on the efficiency of the deal to both the trading parties. It must be apparent to one skilled in the art that the deal may not always be bilateral. The user may also strike a deal with multiple parties as per his/her requirement. An example of a trading mechanism coupled with bilateral negotiations has been explained later in conjunction with FIG. 7. It must be apparent to one skilled in the art that each of the above steps can be carried out either at the server side or at the client side in the corresponding system.

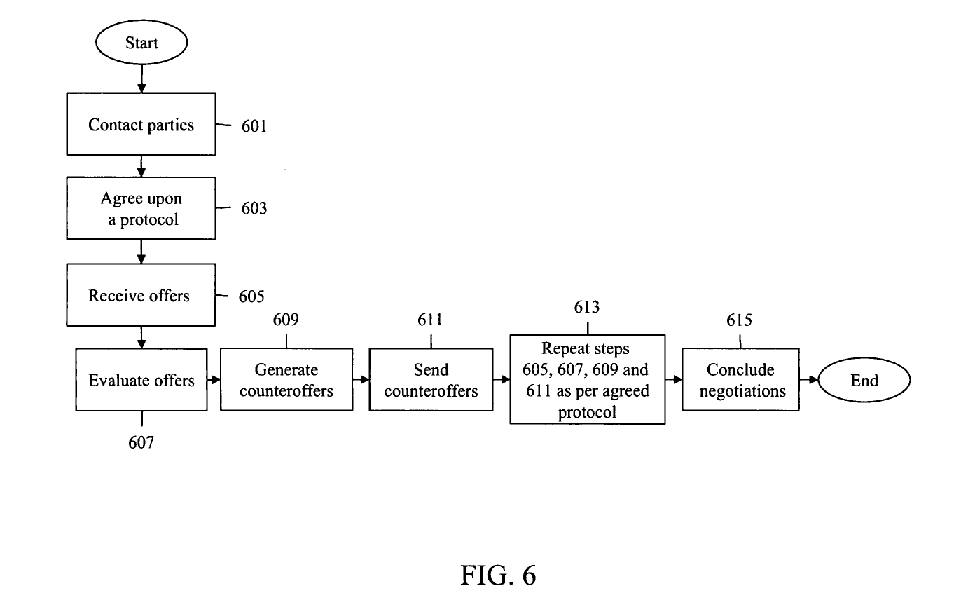

FIG. 6 illustrates the method of invoking bilateral negotiations in accordance with a preferred embodiment of the present invention. As shown in FIG. 6, at step 601 the user starts the negotiation process by contacting the selected trading parties to determine if they are interested in entering bilateral negotiations so that they can strike a deal that is acceptable to the negotiating parties. In case the contacted parties agree, then both the parties agree upon a protocol for conducting the negotiations, as shown at step 603. The protocol is a set of rules and/or policies that define the manner in which the bilateral negotiations are to be conducted between the two parties. The protocol may define rules relating to a number of parameters of the negotiation process, a few examples of which are given below.

Mode of bidding: Mode of bidding will define whether the two parties will exchange bids in a sequential manner, or in a random manner.

Time for completion: This parameter indicates the time after which the bilateral negotiations will be completed. The parties may agree on a last date or may end the negotiations after a specified period of inactivity. The negotiations may also end after a predefined number of bids are exchanged between both the parties. A meaningful combination of these criteria may also be used to indicate the time for completion.

Attributes of individual bids: Attributes of individual bids will include criteria such as whether a bid is a timed bid or whether it is valid only till a specified time period. These may also include whether a bid supersedes earlier bids or may be considered valid along with earlier bids.

Parameters such as whether the bids are built incrementally, whether only one bid may be submitted at a time, or a set of bids may also be define by the protocol.

These parameters are only representative and the protocols supported could vary from very simple protocols with few rules to complex protocols defining many rules relating to many parameters. Based on the specified protocol, users may choose to define their strategies for bidding. A specific framework might provide support for multiple protocols, where the users could select various options for the different parameters of the protocol, and thus define new protocols.

Once the parties have been contacted, and a protocol agreed upon, the user receives the trading offers from various trading parties, as shown at step 605. For the sake of illustration, one trading offer for buying Personal Computers may include number of computers to be bought, cost of each computer, time of delivery, memory space of each computer, processor speed of each computer, etc. At step 607, the user evaluates the trading offers received from the trading party/trading parties at step 605. At step 609, the user generates counter-offers to the offers received at step 605. The counter-offers are generated on the basis of the protocol that was agreed upon at step 603. The counter offers generally allow a user to customize the trading deal as per his/her need and satisfaction. Continuing the example of personal computer, the user may agree upon cost and time of delivery quoted by the trading party, but he/she may decrease the number of computers to be bought, or increase the processor speed specification. As already mentioned, the parameters that can be changed/negotiated are decided when the protocol is being agreed upon at step 603.

Once the counter-offers are generated, the same are sent to the respective trading parties at step 611. The trading parties, based on the counter offers received, send a modified set of offers. Continuing the ongoing example, the trading party may agree upon the processor specified in the counter-offer sent by the user, but may not agree with the reduction in number of computers. Thus, as shown at step 613, the steps 605, 607, 609 and 611 are repeated as per the agreed upon protocol. For instance, the protocol may specify that if after three rounds of counter-offers, a trading deal is not agreed upon, the negotiations shall stop. At step 615, the negotiations conclude. Negotiations may conclude successfully if a trading deal is agreed upon. Negotiations are deemed as ‘failed’ when no trading deal is agreed upon.

FIG. 7 describes an example in which a seller invokes bilateral negotiations in the lifecycle of a sealed bid auction, to facilitate the reaching of a deal/agreement. The seller specifies his/her requirements at step 701. He/she now solicits bids from different buyers, as shown at step 703. The seller receives the bids, as shown at step 705, and evaluates them at step 707. The seller then determines if he/she can ascertain the winning bid(s) based on the bids received, as shown at step 709. If yes, the seller determines the winning bid(s) at step 711. After the winning bid/bids have been determined, the seller terminates the auction at step 713. If the seller is not able to ascertain the winner/winners from the bids received, then, as shown at step 715, the seller determines if there is scope for bilateral negotiations with one or more buyers that could probably lead to improved offers. If the seller feels that there is no scope for bilateral negotiations, then he/she terminates the auction at step 713. However, if the seller feels that there is scope for improving one or more offers through bilateral negotiations, then the seller selects buyer(s) with whom he/she wishes to conduct the bilateral negotiations, as shown at step 717. At step 719, the seller contacts the selected buyer(s) to determine whether those buyer(s) are interested in conducting bilateral negotiations. At step 721, the seller agrees upon a protocol for conducting the negotiations with the interested buyer(s). After the protocol has been mutually agree upon, the seller makes offers to the buyer(s), as shown at step 723, and receives counteroffers from buyer(s), as shown at step 725. The seller then concludes the negotiations at step 727. The received offers are then evaluated by the seller at step 729. The seller may either accept one or more offers or reject the offers, as shown at step 731. The acceptance and rejection of offers will depend upon the attractiveness and feasibility of the trading deal. The seller then terminates the auction at step 713.

The present invention offers the following advantages. Firstly, the present invention provides the trading parties with the flexibility to selectively execute trading mechanisms and bilateral negotiations in order to arrive at attractive and feasible trading deals. Second, the present invention enables the trading parties to customize trading offers through negotiation process in order to arrive at attractive and feasible trading deals. Third, the present invention provides the trading parties with a large number of trading options.

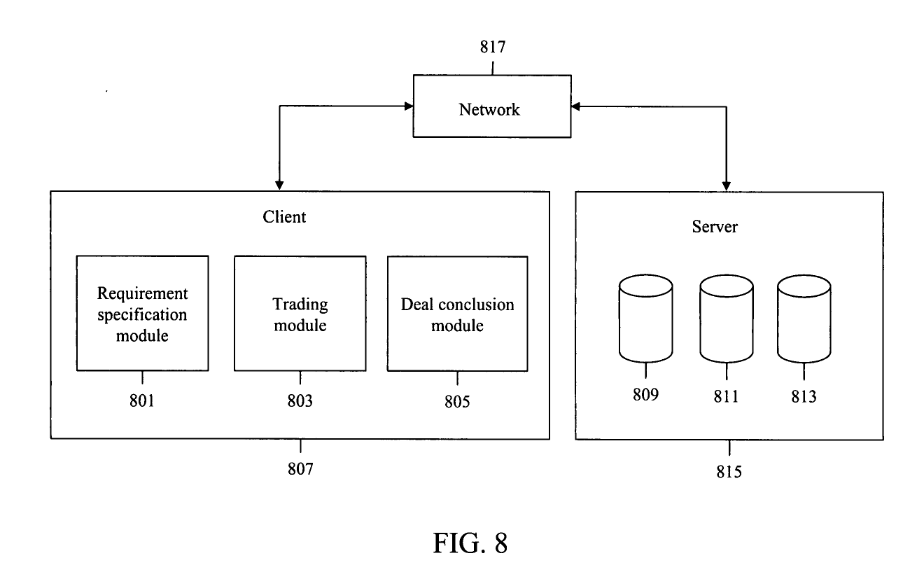

In an alternate embodiment of the present invention illustrated in FIG. 8, initial requirement specification module 801, trading module 803 and deal conclusion module 805 reside on client 807 while requirements repository 809, user repository 811 and past trading deals repository 813 reside on server 815. Client 807 is connected to server 815 through a network 817. The processing load in this embodiment is primarily on clients. Such an embodiment is advantageous in cases wherein the processing load on the server has to be distributed.

In another alternate embodiment of the present invention, the method, system and the computer program product may be implemented in a regulated online market. In this embodiment, the aim of the online market is to improve the overall trading efficiency of the online market. The overall trading efficiency of the online market, in turn, may be defined in a number of ways. For the purpose of illustration, let us consider a case when the trading efficiency is defined to be directly proportional to the number of trading parties that are able to strike a trading deal. Thus, more the number of trading parties striking deals in the online market, more is the trading efficiency of the online market. However, given the regulations that lead to maximization of the number of trading parties striking trading deals in an online market in the case being discussed, the trading deals should also take place in accordance with the satisfaction and needs of the trading parties.

In order to increase the trading efficiencies of the online market, a regulated online market is implemented. The regulated online market ensures that maximum number of trading parties are able to strike a deal. At the same time, it ensures that that deals should take place in accordance with the satisfaction and needs of the trading parties. A typical regulation in a regulated online market may be a time bound regulation. The time bound regulation does not allow a user to strike further deals for a predefined time period after he/she has already struck a predefined number of deals. The predefined time period allows other trading parties to strike deals so that a maximum number of trading parties are able to strike deals in the online market. For example, if a user is selling chairs in the online market and is able to sell ‘n’ chairs, then he/she is not allowed to sell more chairs for a time ‘t’ in the online market. Here ‘n’ specifies the maximum number of deals struck by the user after which he/she will not be allowed to trade further and ‘t’ specifies the time period for which the user will not be allowed to trade in the online market. Both ‘n’ and ‘t’ are predefined in the online market.

An exemplary regulated online market may be an international pharmaceuticals online market. The sellers in the pharmaceuticals market may be drug selling companies of various nations. The buyers of these drugs may be national health agencies of various nations. It is desired that maximum number of nations and companies are able to strike fair deals. In order to achieve this, the World Health Organization may regulate the online market. The regulations in the online market may be a function of a number of parameters. These parameters may include number of people in a particular nation that require the drug or the prevalent cost structure of the drugs in these nations. Therefore, keeping in mind the number of people that require the drug in various nations, the regulations may require restrictions on the quantity of drugs supplied to a particular nation. In a similar manner, considering the cost structure of the drugs in various countries, the regulations may require different selling prices to different nations. These regulations will ensure that maximum number of nations are able to strike deals with the drug companies. At the same time, the regulations may also be imposed on the drug selling companies. These regulations may be time bound regulations as explained earlier.

It must be apparent to one skilled in the art that the present invention may be implemented independently or in conjunction with another market process. In an alternate embodiment, the present invention may also be implemented as a procurement module in an end-to-end supply chain management solution. In such an embodiment, the present invention may be used, for instance, to procure raw materials for a manufacturing unit. In this case, the manufacturing unit acts as a buyer. The present invention may also be implemented to sell the products manufactured by the manufacturing unit.

Hardware and Software Implementation

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

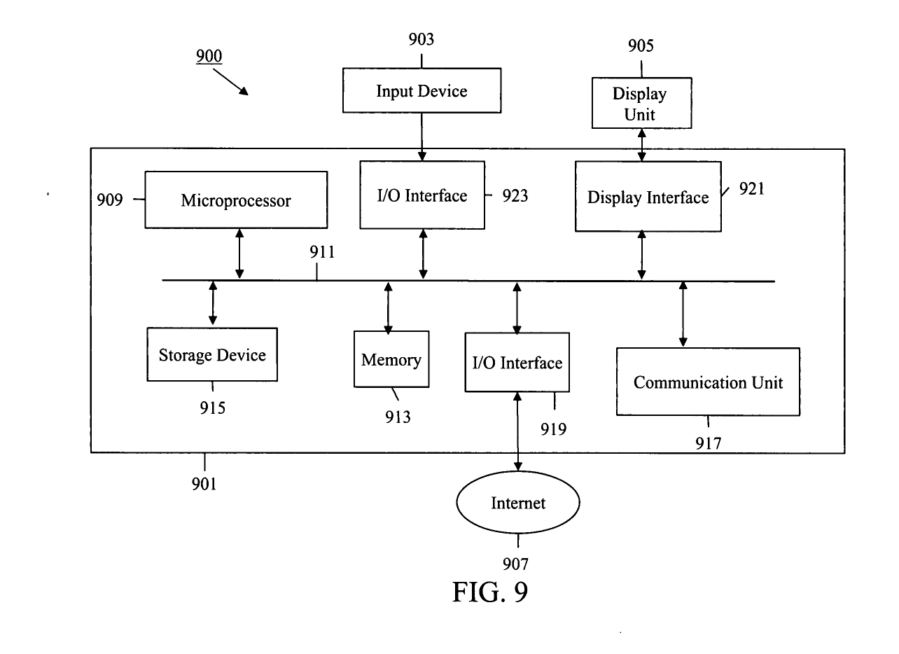

One such computer system has been illustrated in FIG. 9. The computer system 900 comprises a computer 901, an input device 903, a display unit 905 and the Internet 907. Computer 901 comprises a microprocessor 909. Microprocessor 909 is connected to a communication bus 911. Computer 901 also includes a memory 913. Memory 913 may include Random Access Memory (RAM) and Read Only Memory (ROM). Computer 901 further comprises storage device 915. It can be a hard disk drive or a removable storage drive such as a floppy disk drive, optical disk drive and the like. Storage device 915 can also be other similar means for loading computer programs or other instructions into the computer system. The computer system also includes a communication unit 917. Communication unit 917 allows the computer to connect to other databases and Internet 907 through an I/O interface 919. Communication unit 917 allows the transfer as well as reception of data from other databases. Communication unit 917 may include a modem, an Ethernet card or any similar device, which enables the computer system to connect to databases and networks such as LAN, MAN, WAN and the Internet. The computer system also includes a display interface 921 for connecting to display unit 905. The computer system facilitates inputs from a user through input device 903, accessible to the system through I/O interface 923.

The computer system executes a set of instructions that are stored in one or more storage elements, in order to process input data. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as TCP/IP, UDP, ATM or OSI.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method of trading in an online market, the online market comprising a user and a plurality of trading parties, each trading party trying to strike a trading deal with the user, the user specifying thereof requirements for initiating trading in the online market, the method comprising the steps of;
executing at least one trading mechanism to arrive at trading offers, the trading offers being submitted by the trading parties based on the requirements of the user;
selecting at least one trading offer from the trading offers arrived at said step of executing;
invoking bilateral negotiations to arrive at customized trading offers, the bilateral negotiations being invoked with the trading parties whose trading offers were selected at said step of selecting;
repeating said steps of executing, selecting, and invoking until customized trading offers are arrived at;
evaluating the customized trading offers; and
concluding trading deals based on the evaluated trading offers,
whereby trading mechanisms and bilateral negotiations are combined.

2. The method as recited in claim 1 wherein the step of invoking the bilateral negotiations comprises the steps of:
contacting trading parties whose trading offers are selected for the negotiations;
agreeing upon a protocol for conducting the negotiations;
exchanging offers as per the agreed upon protocol; and
concluding the negotiation process as per the agreed upon protocol.

3. The method as recited in claim 2 wherein the step of exchanging offers comprises the steps of:
receiving offers from the trading parties;
evaluating the received offers;
generating counter-offers on the basis of evaluated offers;
sending counter-offers to the respective trading parties; and
repeating said steps of receiving, evaluating, generating and sending in accordance with the agreed upon protocol.

4. The method as recited in claim 1 wherein the online market is a regulated online market, the online market being regulated to increase trading efficiency of the online market, the trading efficiency of the online market being governed by the number of trading parties that strike a trading deal.

5. A method of trading in an online market, the online market comprising a user and a plurality of trading parties, each trading party trying to strike a trading deal with the user, the user specifying thereof requirements for initiating trading in the online market, the method comprising the steps of:
executing at least one trading mechanism to arrive at trading offers, the trading offers being submitted by the trading parties based on the requirements of the user, the step being performed by or in association with the server;
selecting at least one trading offer from the trading offers arrived at said step of executing, the step being performed by or in association with the server;
invoking bilateral negotiations to arrive at customized trading offers, the bilateral negotiations being invoked with the trading parties whose trading offers were selected at said step of selecting, the step being performed by or in association with the server;
repeating said steps of executing, selecting, and invoking until customized trading offers are arrived at, the step being performed by or in association with the server;
evaluating the customized trading offers, the step being performed by or in association with the server; and
concluding trading deals based on the evaluated trading offers, the step being performed by or in association with the server,
whereby trading mechanisms and bilateral negotiations are combined.

6. A method of trading in an online market, the online market comprising a user and a plurality of trading parties, each trading party trying to strike a trading deal with the user, the user specifying thereof requirements for initiating trading in the online market, the method comprising the steps of:
executing at least one trading mechanism to arrive at trading offers, the trading offers being submitted by the trading parties based on the requirements of the user;
selecting at least one trading offer from the trading offers arrived at said step of executing;
invoking bilateral negotiations to arrive at customized trading offers, the bilateral negotiations being invoked with the trading parties whose trading offers were selected at said step of selecting, said step of invoking further comprising:
contacting trading parties whose trading offers are selected for the negotiations;
agreeing upon a protocol for conducting the negotiations;
exchanging offers as per the agreed protocol; and
concluding the negotiation process as per the agreed protocol;
repeating said steps of executing, selecting, and invoking until customized trading offers are arrived at;
evaluating the customized trading offers; and
concluding trading deals on the basis of the evaluated trading offers,
whereby trading mechanisms and bilateral negotiations are combined.

7. A system suitable for trading in an online market, the online market comprising a user and a plurality of trading parties, the system connected to a plurality of clients, the user specifying thereof requirements for initiating trading in the online market using a client, the system comprising:
a server for enabling the trading in the online market, the server comprising:
means for executing at least one trading mechanism to arrive at trading offers, the trading offers being submitted by the trading parties based on the requirements of the user;
means for selecting at least one trading offer from the trading offers submitted by the trading parties;
means for invoking bilateral negotiations to arrive at customized trading offers, the bilateral negotiations being invoked with the trading parties whose trading offers were selected;
means for evaluating the customized trading offers; and
means for concluding trading deals based on the evaluated trading offers.

8. The system as recited in claim 7 wherein the server further comprises:
a repository containing information related to the requirements of trading parties;
a repository containing information related to the past trading deals; and
a repository containing information related to the trading parties.

9. The system as recited in claim 7 wherein the means for invoking the bilateral negotiations comprises:
means for contacting trading parties whose trading offers are selected for the negotiations;
means for agreeing upon a protocol for conducting the negotiations;
means for exchanging offers as per the agreed upon protocol; and
means for concluding the negotiation process as per the agreed upon protocol.

10. The system as recited in claim 9 wherein the means for exchanging offers comprises:
means for receiving offers from the trading parties;
means for evaluating offers received from the trading parties;
means for generating counter-offers on the basis of evaluated offers; and
means for sending the generated counter-offers to respective trading parties.

11. A system suitable for trading in an online market, the online market comprising a user and a plurality of trading parties, the system connected to at least one server, the system comprising:
a plurality of clients, the clients enabling the trading in the online market, each client comprising:
means for specifying the requirements, the requirements being specified by the user to initiate trading in the online market;
means for executing at least one trading mechanism to arrive at trading offers, the trading offers being submitted by the trading parties based on the requirements of the user;
means for selecting at least one trading offer from the trading offers submitted by the trading parties;
means for invoking bilateral negotiations to arrive at customized trading offers, the bilateral negotiations being invoked with the trading parties whose trading offers were selected;
means for evaluating the customized trading offers; and
means for concluding trading deals based on the evaluated trading offers.

12. A computer program product suitable for trading in an online market, the online market comprising a user and a plurality of trading parties, the computer program product comprising:
program instruction means for executing at least one trading mechanism to arrive at trading offers, the trading offers being submitted by the trading parties based on the requirements of the user;
program instruction means for selecting at least one trading offer from the trading offers submitted by the trading parties;
program instruction means for invoking bilateral negotiations to arrive at customized trading offers, the bilateral negotiations being invoked with the trading parties whose trading offers were selected;
program instruction means for evaluating the customized trading offers; and
program instruction means for concluding trading deals based on of the evaluated trading offers.

13. The computer program product as recited in claim 12 wherein the program instruction means for invoking the bilateral negotiations comprises:
program instruction means for contacting parties whose trading offers are selected for the negotiations;
program instruction means for agreeing upon a protocol for conducting the negotiations;
program instruction means for exchanging offers as per the agreed upon protocol; and
program instruction means for concluding the negotiation process as per the agreed upon protocol.

14. The computer program product as recited 13 wherein the program instruction means for exchanging offers comprises:
program instruction means for receiving offers from the trading parties;
program instruction means for evaluating offers received from the trading parties;
program instruction means for generating counter-offers on the basis of evaluated offers; and
program instruction means for sending the generated counter-offers to respective trading parties.

15. A computer program product suitable for trading in an online market, the online market comprising a user and a plurality of trading parties, the computer program product comprising:
program instruction means for executing at least one trading mechanism to arrive at trading offers, the trading offers being submitted by the trading parties based on the requirements of the user, further details of the program instructions associated with the server;
program instruction means for selecting at least one trading offer from the trading offers submitted by the trading parties, further details of the program instructions associated with the server;
program instruction means for invoking bilateral negotiations to arrive at customized trading offers, the bilateral negotiations being invoked with the trading parties whose trading offers were selected, further details of the program instructions associated with the server;
program instruction means for evaluating the customized trading offers, further details of the program instructions associated with the server; and
program instruction means for concluding trading deals based on the evaluated trading offers, further details of the program instructions associated with the server.

16. A computer program product suitable for trading in an online market, the online market comprising a user and a plurality of trading parties, the computer program product comprising:
program instruction means for executing at least one trading mechanism to arrive at trading offers, the trading offers being submitted by the trading parties based on the requirements of the user, further details of the program instructions associated with the client;
program instruction means for selecting at least one trading offer from the trading offers submitted by the trading parties, further details of the program instructions associated with the client;
program instruction means for invoking bilateral negotiations to arrive at customized trading offers, the bilateral negotiations being invoked with the trading parties whose trading offers were selected, further details of the program instructions associated with the client;
program instruction means for evaluating the customized trading offers, further details of the program instructions associated with the client; and
program instruction means for concluding trading deals based on the evaluated trading offers, further details of the program instructions associated with the client.

17. A computer program product suitable for trading in an online market, the online market comprising a user and a plurality of trading parties, the computer program product comprising:
program instruction means for executing at least one trading mechanism to arrive at trading offers, the trading offers being submitted by the trading parties based on the requirements of the user;
program instruction means for selecting at least one trading offer from the trading offers submitted by the trading parties;
program instruction means for invoking bilateral negotiations to arrive at customized trading offers, the bilateral negotiations being invoked with the trading parties whose trading offers were selected, program instruction means for invoking at least one bilateral negotiations comprising:
program instruction means for contacting trading parties whose trading offers are selected for the negotiations;
program instruction means for agreeing upon a protocol for conducting the negotiations;
program instruction means for exchanging offers as per the agreed upon protocol; and
program instruction means for concluding the negotiation process as per the agreed upon protocol;
program instruction means for evaluating the customized trading offers; and
program instruction means for concluding trading deals based on the evaluated trading offers.
